(19) United States
(12) Patent Application Publication
(10) Pub. No.: US 2023/0110843 A1
(43) Pub. Date: Apr. 13, 2023

(54) IMAGE EXTRACTION DEVICE, IMAGE EXTRACTION SYSTEM, IMAGE EXTRACTION METHOD, AND COMPUTER-READABLE STORAGE MEDIUM

(71) Applicant: TOYOTA JIDOSHA KABUSHIKI KAISHA, Toyota-shi (JP)

(72) Inventors: Junichiro TAMAO, Nagoya-shi (JP); Hiroaki NAGASE, Fujisawa-shi (JP); Hirotaka NAKAYAMA, Toyota-shi (JP); Akihiro MOTODA, Toyota-shi (JP); Ryo MIZUNO, Miyoshi-shi (JP)

(73) Assignee: TOYOTA JIDOSHA KABUSHIKI KAISHA, Toyota-shi (JP)

(21) Appl. No.: 17/958,634

(22) Filed: Oct. 3, 2022

(30) Foreign Application Priority Data
Oct. 13, 2021 (JP) 2021-168414

(51) Int. Cl. G06V 20/40; G06V 20/56

(52) U.S. Cl. CPC G06V 20/46; G06V 20/56

(57) ABSTRACT

A center server serving as an image extraction device includes: a collection unit that collects imaging dates and times and imaging locations that are imaging information applied to captured images captured by an imaging device mounted in a vehicle; a search unit that searches for captured images in which a vehicle of a specific user has been captured; and an extraction unit that extracts, out of the captured images that have been searched, a captured image in a range corresponding to imaging information pertaining to a condition input by the specific user.

### CROSS-REFERENCE TO RELATED APPLICATION

This application is based on and claims priority under 35 USC § 119 from Japanese Patent Application No. 2021-168414 filed on Oct. 13, 2021, the disclosure of which is incorporated by reference herein.

### BACKGROUND

### Technical Field

The present disclosure relates to an image extraction device, an image extraction system, an image extraction method, and a computer-readable storage medium that extract captured images in which a vehicle has been captured.

### Related Art

Japanese Patent Application Laid-open (JP-A) No. 2019-120611 discloses a car navigation device that instructs image capture at a timing when a first vehicle and a second vehicle pass each other.

JP-A No. 2019-120611 can only acquire captured images from specific vehicles passing by and cannot always acquire an image of a scene one likes.

### SUMMARY

The present disclosure provides an image extraction device, an image extraction system, an image extraction method, and a computer-readable storage medium that make it possible to extract an image of a scene one likes out of images of one's own face while moving in a vehicle and of that vehicle.

An image extraction device pertaining to a first aspect includes: a collection unit that collects at least one of imaging dates and times and imaging locations that are imaging information applied to captured images captured by an imaging device mounted in a vehicle or installed on a fixture; a search unit that searches for captured images in which a vehicle of a specific user has been captured; and an extraction unit that extracts, out of the captured images that have been searched, a captured image in a range corresponding to imaging information pertaining to a condition input by the specific user.

The image extraction device pertaining to the first aspect is a device that extracts, in response to a request from the specific user, the captured images captured by the imaging device mounted in the vehicle or installed on the fixture. In this image extraction device, the collection unit collects the imaging information applied to the captured images. Here, the captured images include at least one of imaging dates and times and imaging locations. Additionally, in this image extraction device, the search unit searches for captured images in which the vehicle of the specific user has been captured, and the extraction unit extracts a captured image. The captured image that has been extracted is a captured image in a range corresponding to the condition input by the specific user. According to this image extraction device, an image of a scene one likes can be extracted out of images of one's own face while moving in a vehicle and of that vehicle.

An image extraction device pertaining to a second aspect is the first aspect, wherein the collection unit collects identification information corresponding to an identification number of the vehicle of the specific user applied, in addition to the imaging information, to the captured images, and the search unit searches for captured images having the identification information.

According to the image extraction device pertaining to the second aspect, a captured image of the vehicle of the specific user can be extracted based on the identification number.

An image extraction system pertaining to a third aspect includes the image extraction device of the first or second aspect and an on-board unit mounted on one or plural vehicles, wherein the on-board unit includes a storage unit that stores captured images captured by the imaging device and imaging information applied to the captured images, an authorization unit that authorizes provision of the captured images to the image extraction device, and an output unit which, in a case where provision of the captured images is authorized by the authorization unit, outputs to the image extraction device the captured images stored in the storage unit and extracted in the image extraction device.

In the image extraction system pertaining to the third aspect, in a case where provision of the captured images is authorized by the authorization unit in the on-board unit, the output unit outputs to the image extraction device the captured images extracted in the image extraction device. For that reason, according to this image extraction system, provision of the captured images to a third party can be restricted.

An image extraction system pertaining to a fourth aspect is the image extraction system pertaining to the third aspect, wherein the image extraction device includes a provision unit which, in a case where provision of the captured images is authorized by the authorization unit, provides a reward to the user of the vehicle in which the on-board unit is mounted.

In the image extraction system pertaining to the fourth aspect, in a case where provision of the captured images is authorized, the provision unit in the image extraction device provides a reward to the user of the vehicle in which the on-board unit is mounted. According to this image extraction system, provision of the captured images to a third party can be encouraged.

An image extraction method pertaining to a fifth aspect is a method where a computer executes a process to: collect at least one of imaging dates and times and imaging locations that are imaging information applied to captured images captured by an imaging device mounted in a vehicle or installed on a fixture; search for captured images in which a vehicle of a specific user has been captured; and extract, out of the captured images that have been searched, a captured image in a range corresponding to imaging information pertaining to a condition input by the specific user.

The image extraction method pertaining to the fifth aspect extracts, in response to a request from the specific user, the captured images captured by the imaging device mounted in the vehicle or installed on the fixture. This image extraction method collects the imaging information applied to the captured images, searches for captured images in which the vehicle of the specific user has been captured, and extracts a captured image. The captured image that has been extracted is a captured image in a range corresponding to the condition input by the specific user. According to this image extraction method, an image of a scene one likes can be extracted out of images of one's own face while moving in a vehicle and of that vehicle.

A computer-readable storage medium pertaining to a sixth aspect stores a program that causes a computer to execute a process to: collect at least one of imaging dates and times and imaging locations that are imaging information applied to captured images captured by an imaging device mounted in a vehicle or installed on a fixture; search for captured images in which a vehicle of a specific user has been captured; and extract, out of the captured images that have been searched, a captured image in a range corresponding to imaging information pertaining to a condition input by the specific user.

The program stored in the computer-readable storage medium pertaining to the sixth aspect is executed when extracting, in response to a request from the specific user, the captured images captured by the imaging device mounted in the vehicle or installed on the fixture. The computer in which this program is executed collects the imaging information applied to the captured images, searches for captured images in which the vehicle of the specific user has been captured, and extracts a captured image. The captured image that has been extracted is a captured image in a range corresponding to the condition input by the specific user. According to this program, an image of a scene one likes can be extracted out of images of one's own face while moving in a vehicle and of that vehicle.

According to the present disclosure, an image of a scene one likes can be extracted out of images of one's own face while moving in a vehicle and of that vehicle.

### BRIEF DESCRIPTION OF THE DRAWINGS

FIG. 1 is a diagram showing the schematic configuration of an image extraction system pertaining to a first embodiment;

FIG. 2 is a block diagram showing hardware configurations of a vehicle of the first embodiment;

FIG. 3 is a block diagram showing the configuration of a ROM in an on-board unit of the first embodiment;

FIG. 4 is a block diagram showing functional configurations of a CPU in the on-board unit of the first embodiment;

FIG. 5 is a block diagram showing hardware configurations of a center server of the first embodiment;

FIG. 6 is a block diagram showing functional configurations of a CPU in the center server of the first embodiment;

FIG. 7 is a sequence diagram showing a flow of processes in the image extraction system of the first embodiment;

FIG. 8 is a flowchart showing the flow of a response process executed in the on-board unit in the first embodiment;

FIG. 9 is a flowchart showing the flow of a display process executed in a terminal of a prospective user in the first embodiment;

FIG. 10 is a sequence diagram showing a flow of processes in the image extraction system of the first embodiment;

FIG. 11 is a diagram showing the schematic configuration of an image extraction system pertaining to a second embodiment; and

FIG. 12 is a block diagram showing hardware configurations of an information collection device of the second embodiment.

### DETAILED DESCRIPTION

An image extraction system including an image extraction device of the present disclosure will be described. The image extraction system is a system which, in a case where a camera mounted on another vehicle captures an image of a host vehicle driven by a user, receives a provision of the captured image of the host vehicle from the other vehicle.

### First Embodiment

(Overall Configuration)

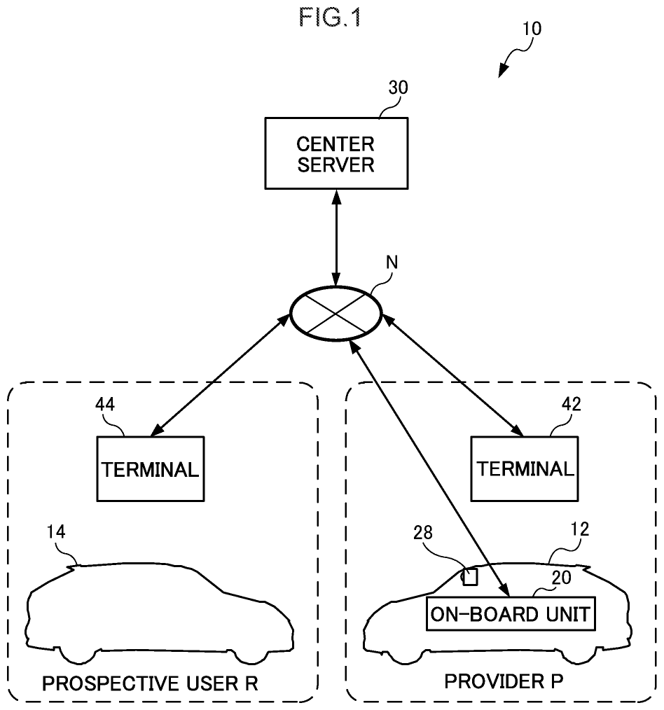

As shown in FIG. 1, an image extraction system 10 of a first embodiment is configured to include a vehicle 12, a center server 30 serving as an image extraction device, a terminal 42, and a terminal 44. In the vehicle 12 are mounted an on-board unit 20 and a camera 28. The on-board unit 20, the center server 30, the terminal 42, and the terminal 44 are connected to each other through a network N. Although FIG. 1 shows one vehicle 12 and on-board unit 20, and one terminal 42 and one terminal 44, with respect to one center server 30, the numbers of the vehicles 12, on-board units 20, terminals 42, and terminals 44 are not limited to these.

The center server 30 is, for example, installed in the location of the manufacturer that manufactures the vehicle 12 or a company operated by the manufacturer. The terminal 42 may, for example, be a smartphone or a personal computer carried by the owner of the vehicle 12. The owner of the vehicle 12 and the terminal 42 is a provider P of captured images and corresponds to a user of the vehicle in which the on-board unit is mounted.

The terminal 44 may, for example, be a smartphone or a personal computer carried by the owner of a vehicle 14 whose image is captured by the vehicle 12. The vehicle 14 corresponds to a vehicle of a specific user. The owner of the vehicle 14 and the terminal 44 is a prospective user R of captured images and corresponds to the specific user.

(Vehicle)

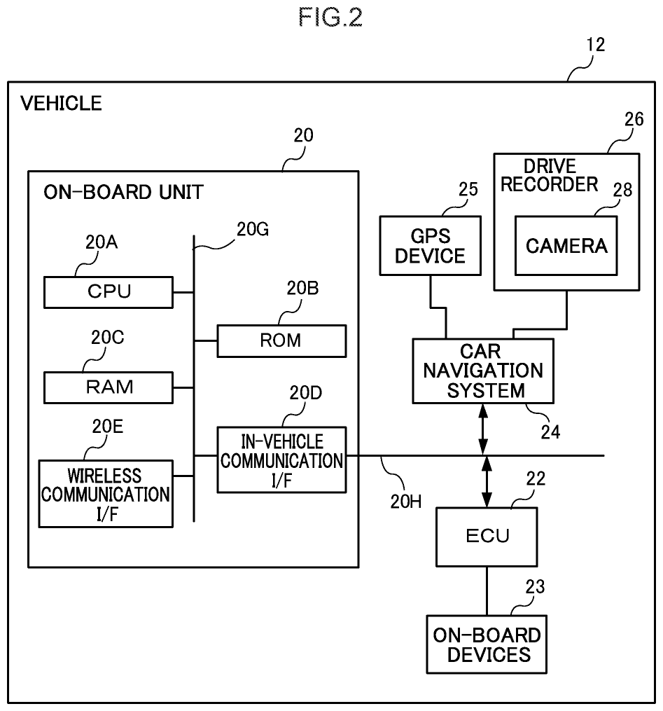

As shown in FIG. 2, the vehicle 12 pertaining to the present embodiment is configured to include the on-board unit 20, an electronic control unit (ECU) 22, on-board devices 23, a car navigation system 24, a GPS device 25, a drive recorder 26, and the camera 28.

The on-board unit 20 is configured to include a central processing unit (CPU) 20A, a read-only memory (ROM) 20B, a random-access memory (RAM) 20C, an in-vehicle communication interface (I/F) 20D, and a wireless communication I/F 20E. The CPU 20A, the ROM 20B, the RAM 20C, the in-vehicle communication UP 20D, and the wireless communication I/F 20E are communicably connected to each other via an internal bus 20.

The CPU 20A is a central arithmetic processing unit, executes various types of programs, and controls each part of the on-board unit 20. That is, the CPU 20A reads programs from the ROM 20B and executes the programs using the RAM 20C as a workspace.

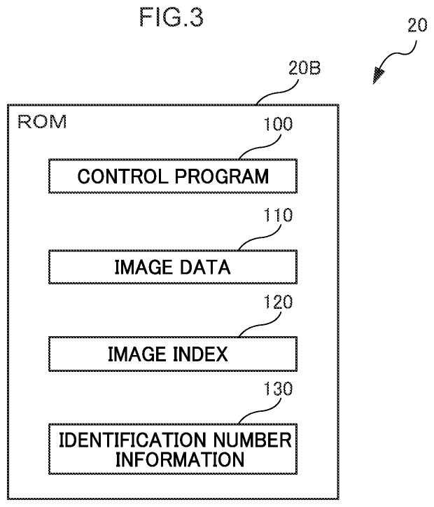

The ROM 20B serving as a storage unit stores various types of programs and various types of data. As shown in FIG. 3, in the ROM 20B of the present embodiment are stored a control program 100, image data 110, an image index 120, and identification number information 130.

The control program 100 executes a process to collect captured images captured by the camera 28 and provide them in response to a request from the center server 30.

The image data 110 are data pertaining to the captured images, which are moving images captured by the camera 28. The image data 110 may also be stored in the drive recorder 26.

The image index 120 is data in which imaging dates and times and imaging locations of the captured images captured by the camera 28 are associated with the captured images.

The identification number information 130 is data pertaining to an identification number that identifies the vehicle 12. The identification number that identifies the vehicle 12 here may, for example, be the license plate number, the vehicle identification number, or another unique number of the vehicle 12.

As shown in FIG. 2, the RAM 20C temporarily stores programs or data as a workspace.

The in-vehicle communication I/F 20D is an interface for connecting to the ECU 22 and the car navigation system 24. The interface uses the CAN communication protocol. The in-vehicle communication I/F 20D is connected to an external bus 20H.

The wireless communication I/F 20E is a wireless communication module for communicating with the center server 30. The wireless communication module uses a communication protocol such as 5G, LTE, or Wi-Fi (registered trademark), for example. The wireless communication I/F 20E is connected to the network N.

The ECU 22 may, for example, be an advanced driver assistance system (ADAS)-ECU, an engine ECU, or a body ECU. The on-board devices 23 are devices such as sensors and actuators connected to the ECU 22. In a case where, for example, the ECU 22 is an ADAS-ECU, the on-board devices 23 may, for example, include a vehicle speed sensor and an acceleration sensor.

The car navigation system 24 is a system that displays the current position of the vehicle 12 on a map and navigates driving routes.

The GPS device 25 is a device that calculates the current position of the vehicle 12, The GPS device 25 includes an antenna (not shown in the drawings) that receives signals from GPS satellites. The (IPS device 25 may also be directly connected to the on-board unit 20.

The drive recorder 26 is provided in the vicinity of the rear-view mirror and is a device that records the moving images captured by the camera 28 that is an imaging device.

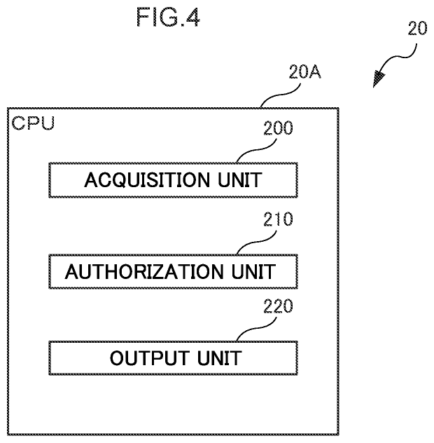

As shown in FIG. 4, in the on-board unit 20 of the present embodiment, the CPU 20A functions as an acquisition unit 200, an authorization unit 210, and an output unit 220 by executing the control program 100.

The acquisition unit 200 has the function of acquiring from the drive recorder 26 the captured images captured by the camera 28. The captured images acquired by the acquisition unit 200 of the present embodiment are moving images, but they are not limited to this and may also be still images.

The authorization unit 210 has the function of deciding whether or not to provide to the center server 30 the captured images captured by the camera 28. In a case where the authorization unit 210 has received a command to authorize provision of the captured image from the terminal 42 carried by the provider P, the authorization unit 210 authorizes provision of the captured images to the center server 30 in response to a request from the center server 30. In a case where the authorization unit 210 has received a command to not authorize provision of the captured image from the terminal 42 carried by the provider P, the authorization unit 210 prohibits provision of the captured images to the center server 30 irrespective of a request from the center server 30.

The output unit 220 has the function of outputting to the center server 30 the captured images captured by the camera 28. In a case where provision of the captured images is not authorized in the authorization unit 210, the output unit 220 outputs to the center server 30 an indication that it cannot provide the captured images.

(Center Server)

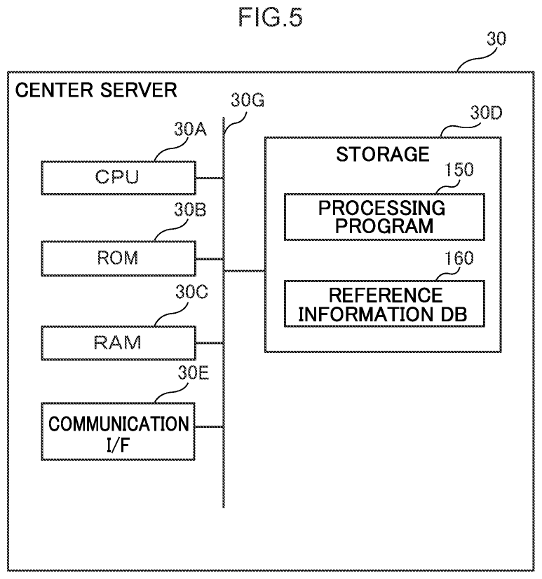

As shown in FIG. 5, the center server 30 is configured to include a CPU 30A, a ROM 30B, a RAM 30C, a storage 30D, and a communication I/F 30E, The CPU 30A, the ROM 30B, the RAM 30C, the storage 30D, and the communication i/F 30E are communicably connected to each other via an internal bus 30G The functions of the CPU 30A, the ROM 30B, the RAM 30C, and the communication I/F 30E are the same as those of the CPU 20A, the ROM 20B, the RAM 20C, and the wireless communication I/F 20E, of the on-board unit 20. The communication I/F 30E may also communicate by wires.

The storage 30D serving as a memory is configured by a hard disk drive (HDD) or a solid-state drive (SSD) and stores various types of programs and various types of data. In the storage 30D of the present embodiment are stored a processing program 150 and a reference information database (DB) 160. The ROM 30B may also store the processing program 150 and the reference information DB 160.

The processing program 150 serving as a program is a program for controlling the center server 30. The center server 30 executes various processes in accompaniment with execution of the processing program 150.

The reference information DB 160 is a database in which are stored the imaging dates and times and the imaging locations of the captured images as well as the identification information of the vehicle 14 appearing in the captured images. In the reference information DB 160 are stored, by each vehicle 12 that has captured the captured images, the imaging dates and times and the imaging locations of the captured images and the identification information of the vehicle 14 whose image that has been captured.

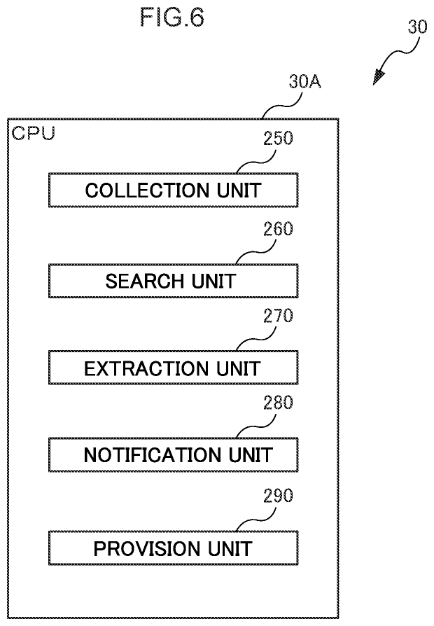

As shown in FIG. 6, in the center server 30 of the present embodiment, the CPU 30A functions as a collection unit 250, a search unit 260, an extraction unit 270, a notification unit 280, and a provision unit 290 by executing the processing program 150.

The collection unit 250 has the function of collecting imaging information that is the imaging dates and times and the imaging locations of the captured images and an identification number serving as identification information relating to the vehicle 14 appearing in the captured images. Here, the identification number of the vehicle 14 may, for example, be the license plate number, the vehicle identification number, or another unique number of the vehicle 14. The imaging information and the identification number are information applied to the captured images captured by the camera 28 mounted in the vehicle 12. The imaging information and the identification number collected by the collection unit 250 are stored in the reference information DB 160 by each vehicle 12.

The search unit 260 has the function of searching for captured images in which the vehicle 14 of the prospective user R has been captured. Specifically, the search unit 260 searches for captured images to which the identification number of the vehicle 14 has been applied in the reference information DB 160 in order to extract captured images in which the vehicle 14 has been captured.

The extraction unit 270 has the function of extracting a specific captured image out of the captured images that have been searched. Specifically, the extraction unit 270 extracts, out of the captured images in which the vehicle 14 appears, a captured image in a range corresponding to imaging information pertaining to a condition input by the prospective user R. For example, in a case where the captured images are moving images, the extraction unit 270 cuts out from the moving images a range (i.e., frame) that meets the condition.

The notification unit 280 has the function of notifying the user of information as to whether or not there are captured images and whether or not the captured images can be provided.

The provision unit 290 has the function of providing a reward to the provider P of the vehicle 12 that has authorized provision of the captured images. Here, “reward” means a value that can be used to purchase goods or provide services, such as e-money, points, and discount coupons. The provision unit 290 sends reward information pertaining to the reward to the terminal 42 of the provider P by whom provision of the captured images is authorized.

(Control Flow)

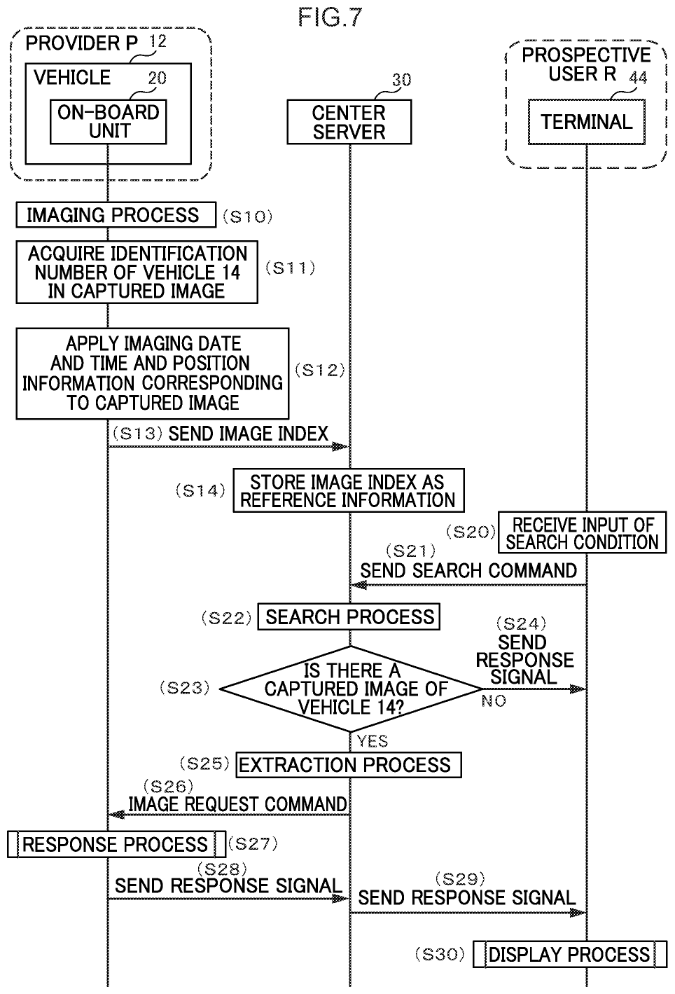

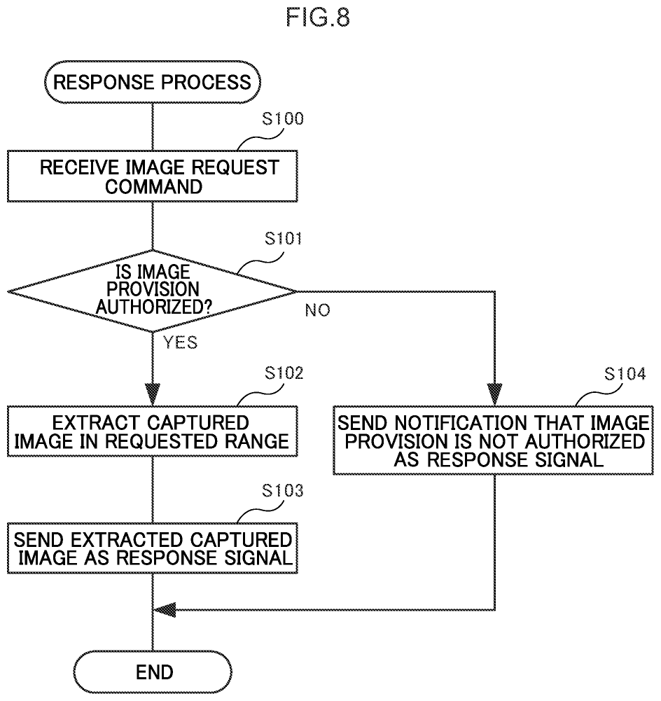

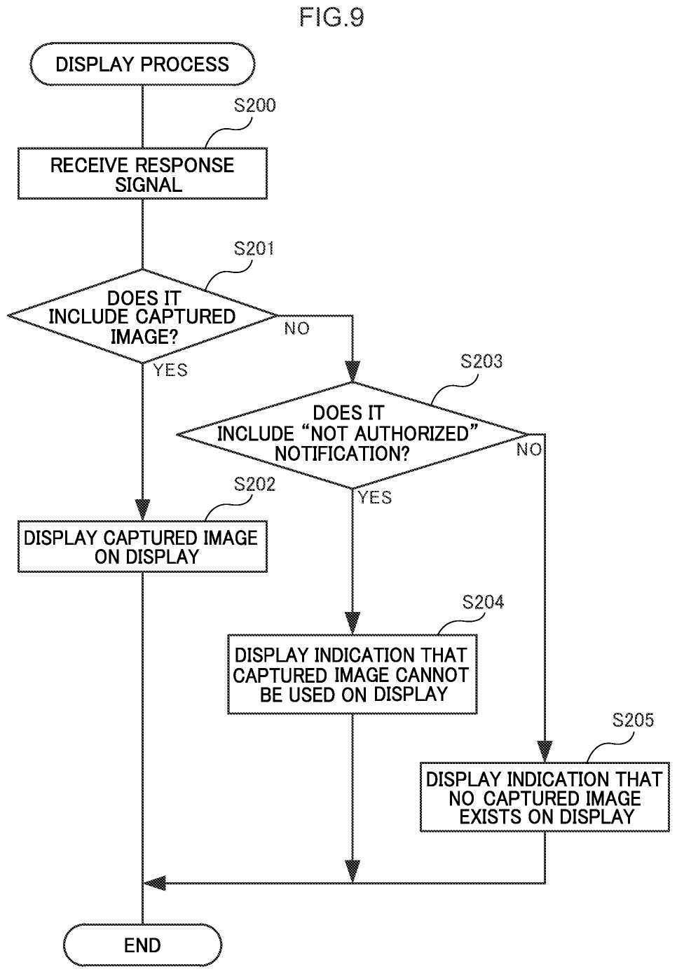

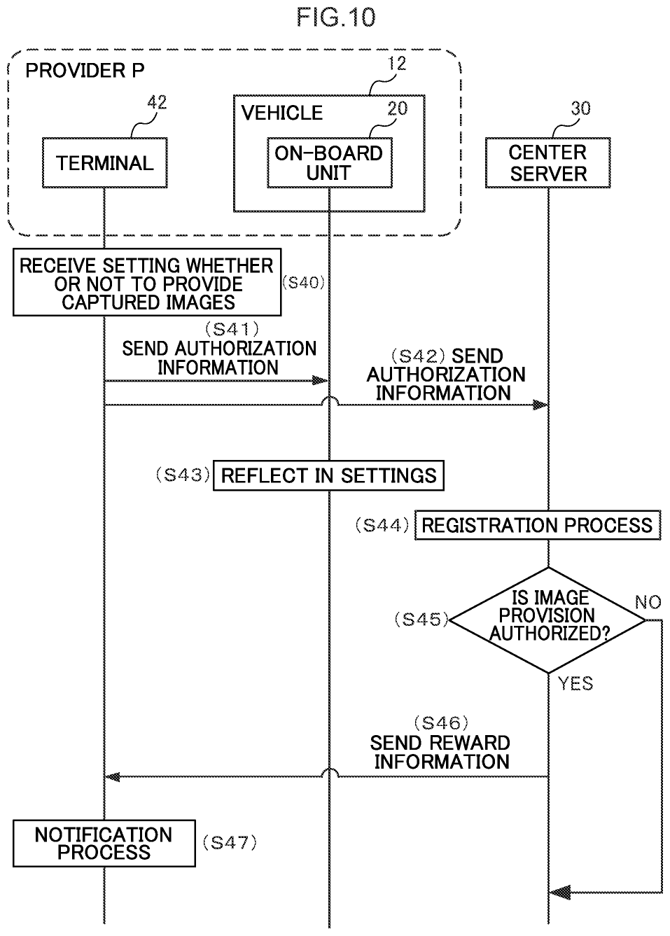

A flow of processes executed by the image extraction system 10 of the present embodiment will now be described using the sequence diagrams of FIG. 7 and FIG. 10 and the flowcharts of FIG. 8 and FIG. 9. Processes in the on-board unit 20 are executed by the CPU 20A of the on-board unit 20 functioning as the acquisition unit 200, the authorization unit 210, and the output unit 220. Furthermore, processes in the center server 30 are executed by the CPU 30A of the center server 30 functioning as the collection unit 250, the search unit 260, the extraction unit 270, the notification unit 280, and the provision unit 290.

First, FIG. 7 shows a flow of processes to provide, in response to a request from the prospective user R, a captured image captured in the vehicle 12.

In step S10 of FIG. 7, the on-board unit 20 executes an imaging process. That is, the area around the vehicle 12 is imaged by the camera 28 mounted in the vehicle 12. Because of this, the on-board unit 20 collects a captured image of one or multiple vehicles 14.

In step S11 the on-board unit 20 acquires the identification number of the vehicle 14 in the captured image. For example, the on-board unit 20 uses known image recognition technology to acquire, as the identification number, the numbers and letters on the license plate.

In step S12 the on-board unit 20 applies an imaging date and time and position information corresponding to the captured image.

In step S13 the on-board unit 20 sends an image index to the center server 30. The image index is information indicating the existence of a captured image in which the vehicle 14 has been captured at a certain time and at a certain position, and the imaging date and time and the imaging location of the captured image and the identification information serving as the identification number of the vehicle 14 whose image has been captured are applied together with the identification information of the vehicle 12 that captured the captured image.

In step S14 the center server 30 stores, as reference information in the storage 30D, the image index received from the on-board unit 20. That is, the image index is stored in the reference information DB 160.

In step S20 the terminal 44 carried by the prospective user R receives input of a search condition input by the prospective user R. As the search condition, any of at least the imaging day, the imaging date and time, and the imaging region is input. It will be noted that the identification number of the vehicle 14 of the prospective user R may also be input as a search condition, and may also be applied beforehand to a search command described later.

In step S21 the terminal 44 on which input of the search condition has been received sends to the center server 30 a search command including the search condition.

In step S22 the center server 30 executes a search process Specifically, the center server 30 searches the reference information DB 160 for captured images in which the vehicle 14 has been captured.

In step S23 the center server 30 determines whether or not there is a captured image of the vehicle 14. In a case where the center server 30 determines that there is not a captured image of the vehicle 14, the center server 30 proceeds to step S24. In a case where the center server 30 determines that there is a captured image of the vehicle 14, the center server 30 proceeds to step S25.

In step S24 the center server 30 sends to the terminal 44 a response signal indicating that there is not a captured image.

In step S25 the center server 30 executes an extraction process. Specifically, the center server 30 extracts an image in a range matching the search condition from the captured images of the vehicle 14 that have been searched.

In step S26 the center server 30 sends to the on-board unit 20 an image request command requesting the captured image has been searched.

In step S27 the on-board unit 20 executes a response process. Details about the response process will be described later.

In step S28 the on-board unit 20 sends a response signal to the center server 30.

In step S29 the center server 30 sends a response signal to the terminal 44. In executing step S29, the center server 30 may also store the result of the response process in the on-board unit 20, that is, information as to whether or not a captured image was provided in response to the request from the prospective user R.

In step S30 the terminal 44 executes a display process. Details about the display process will be described later.

Next, details about the response process of step S27 will be described.

In step S100 of FIG. 8, the CPU 20A receives the image request command.

In step S101 the CPU 20A determines whether or not image provision is authorized. Setting pertaining to the authorization of captured images will be described later. In a case where the CPU 20A determines that image provision is authorized (in the case of YES in step S101), the CPU 20A proceeds to step S102. In a case where the CPU 20A determines that image provision is not authorized (in the case of NO in step S101), the CPU 20A proceeds to step S104.

In step S102 the CPU 20A extracts the captured image in the range that has been requested.

In step S103 the CPU 20A sends to the center server 30 the captured image that has been extracted as a response signal. Then, the response process ends.

In step S104 the CPU 20A sends to the center server 30 a “not authorized” notification indicating that image provision is not possible as a response signal. Then, the response process ends.

Next, details about the display process of step S30 will be described. The display process is executed by a CPU of the terminal 44.

In step S200 of FIG. 9 the terminal 44 receives the response signal.

In step S201 the terminal 44 determines whether or not the response signal includes a captured image. In a case where the terminal 44 determines that the response signal includes a captured image (in the case of YES in step S201), the terminal 44 proceeds to step S202. In a case where the terminal 44 determines that the response signal does not include a captured image (in the case of NO in step S201), the terminal 44 proceeds to step S203.

In step S202 the terminal 44 displays on a display (not shown in the drawings) the captured image it has received. Then, the display process ends.

In step S203 the terminal 44 determines whether or not the response signal includes a “not authorized” notification. In a case where the terminal 44 determines that the response signal includes a “not authorized” notification (in the case of YES in step S203), the terminal 44 proceeds to step S204. In a case where the terminal 44 determines that the response signal does not include a “not authorized” notification (in the case of NO in step S203), that is, in a case where the terminal 44 determines that the response signal includes information indicating that there is no captured image, the terminal 44 proceeds to step S205.

In step S204 the terminal 44 displays on the display (not shown in the drawings) an indication that the captured image that was searched for cannot be used. Then, the display process ends.

In step S205 the terminal 44 displays on the display (not shown in the drawings) an indication that a captured image does not exist as a result of the search. Then, the display process ends.

Next, FIG. 10 shows a flow of processes in a case where the provider P of captured images sets whether or not to provide the captured images captured in the vehicle 12 and receives a reward.

In step S40 the terminal 42 carried by the provider P receives from the provider P a setting as to whether or not to provide the captured images.

In step S41 the terminal 42 sends to the on-board unit 20 authorization information pertaining to whether or not to provide the captured images.

Furthermore, in step S42 the terminal 42 sends the authorization information to the center server 30.

In step S43 the on-board unit 20 reflects the setting pertaining to whether or not to provide the captured images.

In step S44 the center server 30 executes a registration process that registers whether or not to provide the captured images.

In step S45 the center server 30 determines whether or not provision of the captured images is authorized. In a case where the center server 30 determines that provision of the captured images is authorized, the center server 30 proceeds to step S46. In a case where the center server 30 determines that provision of the captured images is not authorized, the center server 30 ends the process.

In step S46 the center server 30 sends to the terminal 42 the reward information pertaining to a reward that can be used in the terminal 42.

In step S47 the terminal 42 executes a notification process. Specifically, the terminal 42 notifies the provider P of the content of the reward information it has acquired.

### SUMMARY

The image extraction system 10 of the present embodiment extracts, in response to a request from the prospective user R, the captured images captured by the camera 28 mounted in the vehicle 12 in the on-board unit 20, the captured images captured by the camera 28 are collected, and the imaging dates and times and the imaging locations, which are imaging information, and the identification information, which is the identification number of the vehicle 14 appearing in the captured images, are applied to the captured images together with the identification information of the vehicle 12.

In the center server 30 serving as an image extraction device, the collection unit 250 collects from the on-board unit 20 the imaging information applied to the captured images. Additionally, the search unit 260 searches for captured images in which the vehicle 14 of the prospective user R has been captured, and the extraction unit 270 extracts a captured image matching the condition input by the prospective user R. The captured image that has been extracted is a frame of a moving image cut out to match the condition input to the terminal 44. According to the present embodiment, an image of a scene one likes can be extracted out of images of one's own face while moving in a vehicle and of that vehicle.

Furthermore, in the image extraction system 10 of the present embodiment, in a case where provision of the captured images is authorized by the authorization unit 210 in the on-board unit 20, the output unit 220 outputs the captured images to the center server 30. For that reason, according to the present embodiment, provision of the captured images to a third party can be restricted.

Furthermore, in the image extraction system 10 of the present embodiment, in a case where provision of the captured images is authorized, the provision unit 290 in the center server 30 provides a reward to the provider P who has authorized provision. For that reason, according to the present embodiment, the user of the vehicle 12 collecting the captured images captured by the camera can be encouraged to provide the captured images to a third party. Furthermore, by increasing the number of captured images that can be provided in the image extraction system 10, further participation by the prospective user R can be encouraged.

### Second Embodiment

The image extraction system 10 of the first embodiment was configured to be able to provide to the prospective user R the captured images captured in the vehicle 12. In contrast, in a second embodiment, the image extraction system 10 is configured to be able to provide to the prospective user R captured images captured by, in addition to the vehicle 12, cameras secured to fixtures on roads and near roads. Below, differences from the first embodiment will be described. Configurations that are the same as those of the first embodiment are assigned the same reference signs.

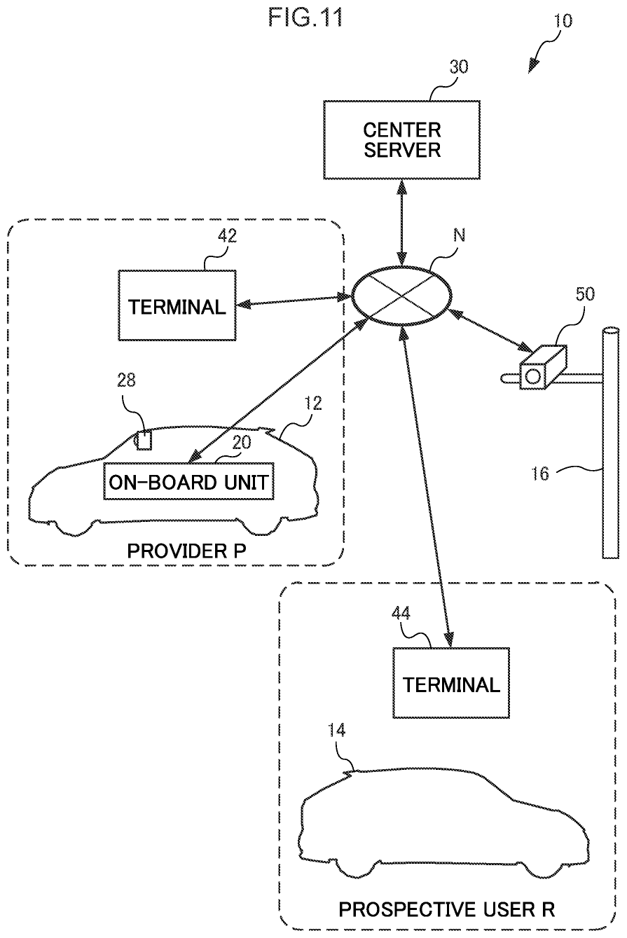

As shown in FIG. 11, the image extraction system 10 of the present embodiment is configured to include the vehicle 12, the center server 30 serving as an image extraction device, the terminal 42, the terminal 44, and an information collection device 50.

The information collection device 50 is, for example, installed on a utility pole 16 that is a fixture, and is configured to be able to capture, with a camera SOD serving as an imaging device, an image of the vehicle 14 driving on a road. The on-board unit 20, the center server 30, the terminal 42, the terminal 44, and the information collection device 50 are connected to each other through the network N.

(Information Collection Device)

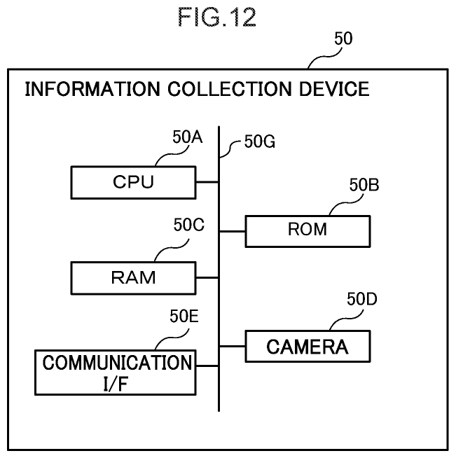

As shown in FIG. 12, the information collection device 50 of the present embodiment is configured to include a CPU 50A, a ROM 50B, a RAM 50C, the camera 50D, and a communication I/F 50E. The CPU 50A, the ROM 50B, the RAM 50C, the camera 50D, and the communication LT 50E are communicably connected to each other via an internal bus 50G The functions of the CPU 50A, the ROM 50B, the RAM 50C, and the communication I/F 50E are the same as those of the CPU 20A, the ROM 20B, the RAM 20C, and the wireless communication i/F 20E of the on-board unit 20.

In the ROM 50B of the present embodiment, as in the ROM 20B of the on-board unit 20, are stored the control program 100, the image data 110, the image index 120, and the identification number information 130 (see FIG. 3). The identification number stored in the identification number information 130 may, for example, be a unique number that can identify the information collection device 50 or the utility pole 16 on which the information collection device 50 is installed.

Furthermore, in the information collection device 50 of the present embodiment, as in the on-board unit 20, the CPU 50A functions as the acquisition unit 200, the authorization unit 210, and the output unit 220 by executing the control program 100.

According to the present embodiment, captured images captured by, in addition to the vehicle 12 driving on roads, cameras installed on fixtures on roads and near roads can be provided to the prospective user R, and even more captured images desired by the prospective user R can be provided.

[Remarks]

In the above embodiments, the center server 30 served as the image extraction device, but the image extraction device is not limited to this, and the on-board unit 20 may also serve as the image extraction device. In this case, the on-board unit 20 is configured to be able to receive the search command directly from the terminal 44 of the prospective user R, execute the search process (step S22) and the extraction process (step S25), and provide the extracted image to the terminal 44.

Furthermore, in the above embodiments, examples of the imaging information collected by the center server 30 included imaging dates and times and imaging locations, but captured image pertaining to the vehicle 14 can be searched and extracted using, as the imaging information, at least either of the imaging dates and times and the imaging locations. Furthermore, captured images pertaining to the vehicle 14 may also be searched and extracted with the imaging information also including, in addition to the imaging dates and times and the imaging locations, the weather at the time of imaging and the driving route of the vehicle 14, for example.

The various types of processes that the CPU 20A, the CPU 30A, and the CPU 50A executed by reading software (programs) in the above embodiments may also be executed by various types of processors other than CPUs. Examples of processors in this case include programmable logic devices (PLDs) whose circuit configuration can be changed after manufacture, such as field-programmable gate arrays (FPGAs), and dedicated electrical circuits that are processors having a circuit configuration dedicatedly designed for executing specific processes, such as application-specific integrated circuits (ASICs). Furthermore, each of the above processes may be executed by one of these various types of processors or may be executed by a combination of two or more processors of the same type or different types (e.g., plural FPGAs, and a combination of a CPU and an FPGA, etc.). Furthermore, the hardware structures of these various types of processors are more specifically electrical circuits in which circuit elements such as semiconductor elements are combined.

Furthermore, in the above embodiments, each program was described as being stored (installed) beforehand in a computer-readable non-transitory recording medium. For example, the control program 100 in the on-board unit 20 is stored beforehand in the ROM 20B, and the processing program 150 in the center server 30 is stored beforehand in the storage 3011). However, the programs are not limited to this and may also be provided in a form in which they are recorded in a non-transitory recording medium such as a compact disc read-only memory (CD-ROM), a digital versatile disc read-only memory (DVD-ROM), and a universal serial bus (USB) memory. Furthermore, the programs may also take a form in which they are downloaded via a network from an external device.

The flows of processes described in the above embodiments are examples, and unnecessary steps may be omitted, new steps may be added, and process orders may be changed in a range that does not depart from the spirit, thereof.

What is claimed is:

1. An image extraction device comprising a processor that is configured to:
collect at least one of imaging dates and times and imaging locations that are imaging information applied to captured images captured by an imaging device mounted in a vehicle or installed on a fixture;
search for captured images in which a vehicle of a specific user has been captured; and
extract, out of the captured images that have been searched, a captured image in a range corresponding to imaging information pertaining to a condition input by the specific user.

2. The image extraction device of claim 1, wherein the processor is configured to:
collect identification information corresponding to an identification number of the vehicle of the specific user applied, in addition to the imaging information, to the captured, images, and
search for captured images having the identification information.

3. An image extraction system comprising the image extraction device of claim 1 and an on-board unit mounted on one or a plurality of vehicles, wherein the on-board unit includes
a memory that stores captured images captured by the imaging device and imaging information applied to the captured images, and
a second processor that is configured to:
authorize provision of the captured images to the image extraction device, and
in a case where provision of the captured images is authorized, output to the image extraction device the captured images stored in the memory and extracted in the image extraction device.

4. The image extraction system of claim 3, wherein the image extraction device is configured to provide, in a case where provision of the captured images is authorized by the authorization unit, a reward to the user of the vehicle in which the on-board unit is mounted,

5. An image extraction system comprising the image extraction device of claim 2 and an on-board unit mounted on one or a plurality of vehicles, wherein the on-board unit includes
a memory that stores captured images captured by the imaging device and imaging information applied to the captured images, and
a second processor that is configured to:
authorize provision of the captured images to the image extraction device, and
in a case where provision of the captured images is authorized, output to the image extraction device the captured images stored in the memory and extracted in the image extraction device.

6. The image extraction system of claim 5, wherein the image extraction device is configured to provide, in a case where provision of the captured images is authorized by the authorization unit, a reward to the user of the vehicle in which the on-board unit is mounted.

7. An image extraction method where a computer executes a process to:
collect at least one of imaging dates and times and imaging locations that are imaging information applied to captured images captured by an imaging device mounted in a vehicle or installed on a fixture;
search for captured images in which a vehicle of a specific user has been captured; and
extract, out of the captured images that have been searched, a captured image in a range corresponding to imaging information pertaining to a condition input by the specific user.

8. A non-transitory computer-readable storage medium that stores a program that causes a computer to execute a process to:
collect at least one of imaging dates and times and imaging locations that are imaging information applied to captured images captured by an imaging device mounted in a vehicle or installed on a fixture;
search for captured images in which a vehicle of a specific user has been captured; and
extract, out of the captured images that have been searched, a captured image in a range corresponding to imaging information pertaining to a condition input by the specific user.
